(19) United States
(12) Patent Application Publication
(10) Pub. No.: US 2025/0348456 A1
(43) Pub. Date: Nov. 13, 2025

(54) COUPLING NETWORK-ON-CHIP SUB-TOPOLOGIES WITH DERIVATIVE CLOCKS

(71) Applicant: Signature IP Corporation, Milpitas, CA (US)

(72) Inventors: Michael Loe Fernandez, Quezon City (PH); Kishore Mishra, Santa Clara, CA (US); Jertrude Fides Olaer Seguisa, Las Piñas City (PH); Parag Bhatt, San Jose, CA (US)

(73) Assignee: Signature IP Corporation, Milpitas, CA (US)

(21) Appl. No.: 19/200,748

(22) Filed: May 7, 2025

Related U.S. Application Data
(60) Provisional application No. 63/643,941, filed on May 8, 2024.
(60) Provisional application No. 63/663,205, filed on Jun. 24, 2024.
(60) Provisional application No. 63/688,925, filed on Aug. 30, 2024.

(51) Int. Cl. G06F 15/78; G06F 1/12

(52) U.S. Cl. CPC G06F 15/7825; G06F 1/12

(57) ABSTRACT

Techniques for interfacing electronics are disclosed. A system-on-chip is accessed. The system-on-chip includes a network-on-chip (NoC) topology. The NoC sub-topologies are based on a physical location of the plurality of logic blocks. A first sub-topology is coupled to a receiving block, wherein the coupling includes inserting an interfacing block. The interfacing block includes a digital PLL (DPLL). The first sub-topology sends to the interfacing block data and a first clock. The first clock is input to the DPLL and used as a reference clock. The DPLL generates a second clock that is used to save the data that was sent. The interfacing block forwards to the receiving block the second clock and the data that was saved. The second clock is used as the internal clock in the receiving sub-topology. The NoC communications includes packets. Additional interfacing blocks are instantiated as necessary.

### RELATED APPLICATIONS

This application claims the benefit of U.S. provisional patent applications “Coupling Network-On-Chip Sub-Topologies With Derivative Clocks” Ser. No. 63/643,941, filed May 8, 2024, “Cloud-Native Network-On-Chip Validation With Sub-Topologies” Ser. No. 63/663,205, filed Jun. 24, 2024, and “Cloud-Native Network-On-Chip Validation Including Sub-Topologies” Ser. No. 63/688,925, filed Aug. 30, 2024.

Each of the foregoing applications is hereby incorporated by reference in its entirety.

### FIELD OF ART

This application relates generally to interfacing electronics and more particularly to coupling network-on-chip sub-topologies with derivative clocks.

### BACKGROUND

From the beginning of time, humans have made use of data. An example of data can be a mental record of observable weather patterns such as a tornado or hurricane that necessitate caution when similar patterns are again observed. Another example of the utility of data can be a written record of events that lead to a useful outcome such as medical results that drive surgical advances. Data can be a record of digital values that reveal the activities of an operator of a vehicle involved in an accident. Data can reveal a reveal the dysfunctional performance of machinery involved in a disaster. Data can be used to learn from history. Historical data can be recent within nanoseconds or ancient by hundreds of years or more. Sharing data can benefit more than one person. Sharing data can benefit society by influencing advancements, safety protocols, security measures, and more.

Not long ago, data sharing was limited to print medium. Sharing options for needed information included printed journals, mail distribution, and the like. One effective option to share data was a local library. Today, many additional forms of data exist including digital formats. Further, advances in computing and the Internet have caused an exponential increase in the amount of data generated and stored. These same advances have created a need for data sharing as collaboration between many users is often required for management, design, engineering, and simple collaborative tasks such as sharing a “to do” list. Instead of traveling to a local library, data can easily be shared on a network. Data communications can be unidirectional or bidirectional. Unidirectional communication can be used to simply broadcast an event, status, conditions, and so on. Bidirectional communications can be used to share data back and forth. An example of bidirectional communication can be file sharing where one or more users share access and update a single document. Other resources can be shared as well, including file servers, printers, machine tools, building control systems, weather stations, air traffic control communication devices, remote control radio and television transmitters, and much more. Data sharing networks can include copper and other cables, telephone lines, wireless links, infrared optical communications devices, fiber optic networks, satellite communications, and so on. Regardless of the specific network employed, the need to share data will continue to grow. As a result, society will greatly benefit as new ways of data sharing and new and faster network capabilities are created.

### SUMMARY

Microprocessors have evolved into large multicore devices that are complete systems on a chip. A system-on-chip (SoC) can integrate nearly all of the components or subsystems of a computational system into a single chip. Embedded cores in a SoC can include one or more microcontroller cores, microprocessor cores, digital signal processor cores, application-specific cores, and so on. Other cores or subsystems in an SoC can include memory and memory interface cores, input/output cores and controllers, clock generators such as digital phase locked loop (DPLL) devices, other timing sources, real-time clock functions, oscillators, counters, watchdog circuitry, power on reset (POR) functions, voltage regulators and power management function digital and analog interfaces. Almost all electronic devices, especially microprocessors, require some kind of clocking structure, which can be difficult to implement on SoC structures.

Techniques for coupling network-on-chip sub-topologies with derivative clocks are disclosed. A system-on-chip is accessed. The system-on-chip includes a network-on-chip (NoC) sub-topology. The NoC sub-topologies are based on a physical location of the plurality of logic blocks. A first sub-topology is coupled to a receiving block, wherein the coupling includes inserting an interfacing block. The interfacing block includes a digital PLL (DPLL). The first sub-topology sends, to the interfacing block, data and a first clock. The first clock is input to the DPLL and used as a reference clock. The DPLL generates a second clock that is used to save the data that was sent. The interfacing block forwards, to the receiving block, the second clock and the data that was saved. The second clock is used as the internal clock in the receiving sub-topology. The NoC communications include packets. Additional interfacing blocks are instantiated as necessary.

A processor-implemented method for interfacing electronics is disclosed comprising: accessing a system-on-chip (SoC), wherein the SoC includes a plurality of subsystems, wherein each subsystem in the plurality of subsystems includes a plurality of logic blocks, wherein the SoC includes a network-on-chip (NoC) topology, wherein the NoC topology includes a plurality of sub-topologies, wherein a location of each sub-topology within the plurality of sub-topologies is based on a physical location of the plurality of logic blocks; coupling a first sub-topology within the plurality of sub-topologies to a receiving block, wherein the coupling includes inserting an interfacing block, wherein the interfacing block includes a first digital phased lock loop (DPLL); sending, by the first sub-topology, to the interfacing block, data and a first clock, wherein the first clock provides an input to the first DPLL; generating, by the first DPLL, a second clock, wherein the generating includes saving, by the interfacing block, the data that was sent; and forwarding, to the receiving block, by the interfacing block, the second clock, wherein the forwarding includes the data that was saved, and wherein the forwarding includes synchronizing the data that was saved with the second clock. Embodiments include employing, by the second sub-topology, the second clock as a second sub-topology internal clock. In other embodiments, the NoC communications protocol includes packets. In embodiments, the receiving block comprises a second interfacing block. Some embodiments comprise creating, by the second interfacing block, a third clock, wherein the creating is based on a second DPLL within the second interfacing block, and wherein the creating includes storing the data that was forwarded.

Various features, aspects, and advantages of various embodiments will become more apparent from the following further description.

### BRIEF DESCRIPTION OF THE DRAWINGS

The following detailed description of certain embodiments may be understood by reference to the following figures wherein:

FIG. 1 is a flow diagram for coupling network-on-chip sub-topologies with derivative clocks.

FIG. 2 is a flow diagram for placing an additional interfacing block.

FIG. 3 is an example of a NoC with sub-topologies.

FIG. 4 is an example of a NoC with sub-topologies and interfacing blocks.

FIG. 5 is a detail of an interfacing block.

FIG. 6 is an example of multiple interfacing blocks in series.

FIG. 7 is an example of interfacing blocks in parallel.

FIG. 8 is a system diagram for coupling network-on-chip sub-topologies with derivative clocks.

### DETAILED DESCRIPTION

Microprocessors have played a significant role in everyday life over the decades since they were developed. Early microprocessors often served a singular role as a CPU. In a computer system, other devices and circuitry, such as memory interfaces, input-output interfaces, graphics processing units (GPUs), communications interfaces, and so on, need to be interconnected with the CPU. Microprocessor technology advances have resulted in large multicore devices that are complete systems on a chip. A system-on-chip (SoC) can integrate nearly all of the components or subsystems of a computational system into a single chip or stack of chips. SoCs are commonly found in embedded systems, where an embedded system is an electronic device that includes one or more processors. SoCs are commonly found in mobile computing platforms from laptops, to tablets, mobile phones, and so on. SoCs are used in personal computers. An SoC can include one or more processor cores and often has many processor cores of different types. Processor cores can include microcontroller cores, microprocessor cores, digital signal processor cores, input/output cores, application-specific cores, and so on. The processors can utilize the ARM architecture and other architectures. Processor cores can be hard cores which are dedicated processors in function, having a fixed floorplan area. Some processor cores can be soft cores which can be implemented in programmable logic circuitry and other platforms in some SoCs. Embedded cores in an SoC can include memory and memory interface cores.

Memory can comprise a memory hierarchy that can include a cache hierarchy. Embedded memory can include flash memory, random-access-memory (RAM), read-only-memory (ROM), electrically erasable programmable read only memory (EEPROM), and other types. RAM can include fast static RAM and slower dynamic RAM (DRAM). Processor cores can include digital signal processors (DSPs). DSPs can be used for processing signals from data collection devices, sensors, feedback devices, video devices, audio devices, and other devices. Processor cores can include any number of logic blocks including clock generators such as PLLs, other timing sources, real time clock functions, oscillators, counters, watchdog circuitry, power on reset (POR) functions, logic functions, local memory, and so on. Processor cores can include voltage regulators and power management functions. Additionally, processor cores can include digital interfaces. Typical low-speed digital interfaces can include inter-integrated circuit (I2C), serial peripheral interface (SPI), USART serial interfaces, pulse width modulation (PWM) interfaces, and so on. Typical high-speed digital interfaces can include USB, Ethernet, Fire Wire, and so on. Other digital interfaces can include video and audio interfaces such as HDMI, CSI, and so on. Processor cores can include analog interfaces such as analog-to-digital converters (ADCs), digital-to-analog converters (DACs), and others.

A core, or subsystem, on an SoC can communicate with other cores or subsystems. Communications can include data transfer and synchronization, flow control, system coordination and messaging, and so on. Some of the subsystems or cores on an SoC can be connected by a bus structure such as the advanced microcontroller bus architecture (AMBA) standard. Bus structures can include a shared bus structure, a hierarchical bus structure, a matrix or crossbar structure, and other variants. However, bus architectures do not scale well with increasing chip size, operating frequency, and density trends due to finite wire delay. Being a shared bus, bus contention can become a significant limiting factor in communication speed. The bus structures that have been commonly used for communication between and among cores fall short of requirements due to increases in chip size, operating frequency, and chip density. Finite wire delay causes issues with data synchronization. Shared bus contention can become a significant limiting factor in communication speed. A more recent trend in SoC subsystem communications has been to replace direct wiring between complex logic blocks with network-on-chip (NoC) technology. NoC technology can implement interconnection structures that can include router-based, packet switching networks, and others. A logic block or subsystem in a NoC-based chip can have an associated router. A logic block can have a network interface that is the connection between the logic functionality and the network. The data can be directed by a router that effects the communications protocol. A logic block or core can have a router, and the combination is known as a node. The data in one node is then placed on the physical link that carries the data to the next node.

Despite the advances of NoC technology, the realities of finite latency and bandwidth within a core or logic block can cause issues if the connections within the logic block are too distant from the nearest NoC node. Wire delay can become insurmountable and does not scale well with chip density. Synchronization and timing closure can thereby present performance limitations despite optimization in floor planning.

A more recent trend in SoC subsystem communications has been to implement network-like topologies that replace bus topologies. Network-on-chip (NoC) technology can implement interconnection structures that can include router-based, packet switching networks, and others. NoC technology can bring significant improvements over conventional bus architectures. Networks can be implemented in a number of network topologies. Network topologies can be direct or indirect topologies. Direct topologies can include a router that is associated with each subsystem and directs messages in and out of the subsystem. A message between two subsystems can travel through one or more routers that are associated with subsystems. Indirect topologies can include routers that are not connected to subsystems, but exist only to carry messages to other routers.

Limitations during floor planning may necessitate long wire paths from a sending sub-topology to a receiving block. In embodiments, the receiving block is a second sub-topology. Long wire paths can introduce RC delays into signal propagation. Long RC delays, which do not scale as feature sizes are reduced in subsequent manufacturing technologies, can be introduced into the design that can cause timing misses. Overall performance can be degraded.

The disclosed technique includes a digital phase locked loop (DPLL). A digital phase locked loop (DPLL) is a device that generates an output signal that is fixed relative to the phase of an input signal by the use of a controlled variable oscillator and feedback to a phase detector that keeps input and output in step. A DPLL can have an output frequency that is a multiple of an input frequency. A DPLL uses the principles of phase control and internal feedback and can be used for derived clock generation, clock synchronization, clock stability, clock multiplication, and so on. SoC performance is improved by coupling network-on-chip sub-topologies with derivative clocks.

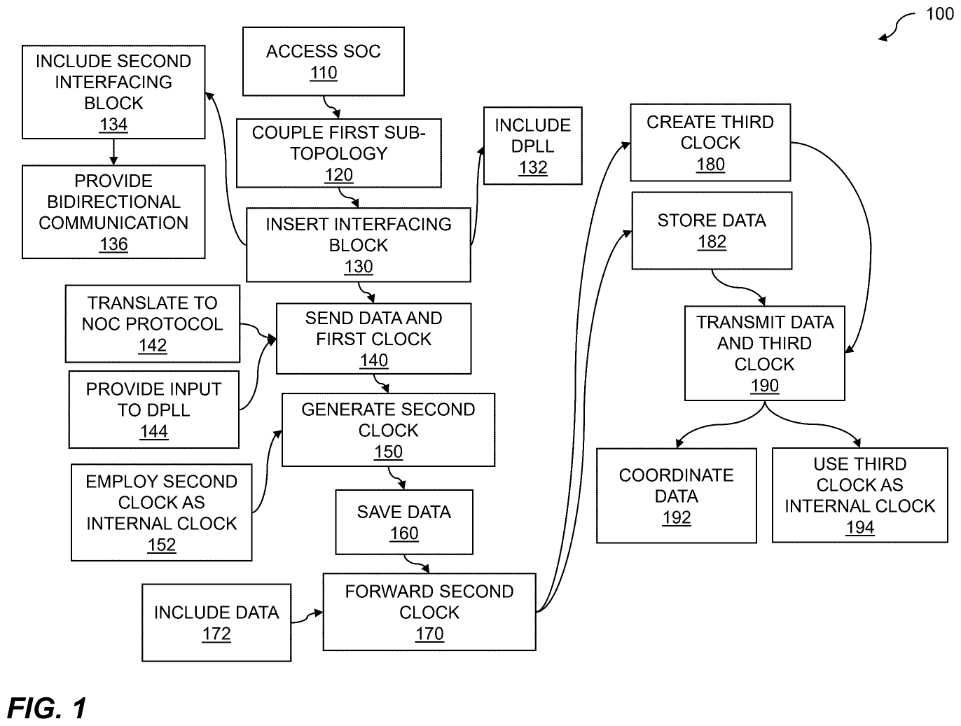

FIG. 1 is a flow diagram for coupling network-on-chip sub-topologies with derivative clocks. The flow 100 includes accessing a system-on-chip (SoC) 110, wherein the SoC includes a plurality of subsystems, wherein each subsystem in the plurality of subsystems includes a plurality of logic blocks, wherein the SoC includes a network-on-a chip (NoC) topology, wherein the NoC topology includes a plurality of sub-topologies, wherein a location of each sub-topology within the plurality of sub-topologies is based on a physical location of the plurality of logic blocks. In embodiments, the SoC can include most or all of the components of a computer system, control system, and the like. The SoC can be comprised of a single chip, or a set of layered chips. The multiple chips can be in a package on package (POP) arrangement. The SoC can include one or more of subsystems, central processing units (CPUs), logic blocks, memories, memory interfaces, input/output interfaces, graphic processing units (GPUs), digital signal processors (DSPs), communications interfaces, analog and mixed signal subsystems, power management units, code security subsystems, clock and timing generation systems, and so on. CPUs can include microprocessors, microcontrollers, and other cores. Memory can include a hierarchy of primary and secondary memory elements as flash memory, read only memory (ROM), electrically erasable programmable ROM (EEPROM), random access memory (RAM), and more. RAM can be static or dynamic, with their speed and power consumption often being factors in design. Cache memory can be included in the CPU design. One or more components above can be included in a system within the SoC.

Communications can occur between and among logic blocks in a subsystem. Communications mechanisms can include local buses. Where local buses become constraining and limiting, a NoC topology can offer the improvements of router-based packetized communications within a subsystem. NoC topologies can provide router-based packetized communications between subsystems. The NoC topology can include a communications structure such as a ring, an n-dimensional mesh, a torus, a k-ary tree, a cube mesh, or any other structure. The NoC can be divided into sub-topologies. The physical location of each NoC sub-topology can be arranged within the SoC to optimize communications between the subsystems. The sub-topologies can include logic, a network interface, a router, physical wiring, a network interface between the logic blocks in a subsystem, and so on. The network interface can translate between communications protocols utilized by various subsystems on the SoC. The network interface can thereby isolate the subsystem logic from the network. NoC topology can include a router that directs packetized traffic to other sub-topologies within and outside of the subsystem. The sub-topologies can include one or more nodes. Physical links can include wiring between nodes that carry packetized communication and network control signals.

The flow 100 includes coupling a first sub-topology 120 within the plurality of sub-topologies to a receiving block, wherein the coupling includes inserting an interfacing block 130, wherein the interfacing block includes a first digital phased lock loop (DPLL) 132. A first sub-topology 120 in an SoC subsystem can be coupled to a receiving block within the subsystem or in a different subsystem on the SoC. In embodiments, the receiving block comprises a second interfacing block. Coupling can be for the purpose of synchronizing data between sub-topologies. For example, limitations during floor planning may necessitate a long wire path from a sending sub-topology to a receiving block. Long wire paths can introduce RC delays into signal propagation. Depending on frequency requirements, such cases may require a pipeline stage to be added. Embodiments include inserting an interfacing block that provides the necessary pipeline stage to reduce path delays. Any number of interfacing blocks can be inserted within or between sub-topologies. The interfacing block can include data buffers. In embodiments, the interfacing blocks are used when a sending sub-topology is sending data to a receiving block with a different width data bus. For example, if the sending sub-topology with a 64-bit data bus sends data to a receiving block with a 32-bit data bus, buffers within an interfacing block must store up to 32 bits of data per clock cycle in order to prevent data loss. Thus, the interfacing blocks can transfer data between sub-topologies with different width data buses. In embodiments, the interfacing block is located in a same subsystem in the plurality of subsystems as the receiving block. In other embodiments, the interfacing block is located in a different subsystem in the plurality of subsystems than the receiving block. The interfacing block can include a DPLL 132. The sending sub-topology can send a clock input to the DPLL 132, which can be a first clock. The first clock can be used as a reference frequency. The DPLL 132 can generate an output clock with a frequency that is different than the input clock frequency. The output clock can comprise a second clock. In embodiments, the first clock and the second clock are based on different clock frequencies. In further embodiments, the second clock is a multiple of the first clock.

As an example, a first subsystem with its sub-topology can run at a frequency A, and a second subsystem and sub-topology can run at frequency B. The DPLL can accept a clock running at frequency A from the first topology and create a second clock at frequency B to send to the second subsystem. The DPLL configuration can be set to generate a multiple of the input frequency that will be made available at the DPLL output for the second sub-topology. The second clock can be used as the clock for the second subsystem.

In embodiments, the receiving block comprises a second interfacing block. Limitations during floor planning may reveal additional long wire paths from a sending sub-topology to a receiving sub-topology. This can require more than one pipeline stage to be added. In embodiments, a first interfacing block can be added between the sending and receiving sub-topologies. In other embodiments, a second interfacing block is added between the sending and receiving sub-topologies. The first and second interfacing blocks can include data buffers. As described previously, the interfacing blocks can be used when a sending sub-topology is sending data to a receiving sub-topology with a different width data bus in order to prevent data loss. In other embodiments, the receiving block comprises a second sub-topology, wherein the second sub-topology is within the plurality of sub-topologies. This can occur when floor planning reveals that the receiving block can successfully receive data from the first sub-topology without the need for an additional interfacing block. In embodiments, the data comprises a communication between NoC subsystems. In embodiments, the inserting includes a second interfacing block, wherein the second interfacing block provides bi-directional communication 136 between the first sub-topology and the receiving block. The established communications protocol can include handshaking between the first sub-technology and the receiving blocks. Handshaking can include read signals, write signals, and so on.

The flow 100 includes sending, by the first sub-topology, to the interfacing block, data and a first clock 140, wherein the first clock provides an input to the first DPLL. As described above and throughout, a first NoC sub-topology can send data to an interfacing block. The first sub-topology can communicate with logic blocks within the NoC subsystem that need to communicate with other subsystems within the SoC. The logic blocks can use a custom communications protocol to optimize performance within the blocks. Thus, embodiments include translating 142, from a protocol running on the one or more logic blocks, to a NoC communications protocol. In embodiments, the NoC communications protocol is coherent. In other embodiments, the NoC communications protocol is non-coherent. The NoC communications protocol can be a mix of coherent and non-coherent logic segments to accommodate the policies of the logic blocks. Communication between the sub-topology and the logic block can include coherent communications protocols such as AMBA 5 CHI, or non-coherent communications protocols such as AXI. In embodiments, the NoC communications protocol includes packets. Recall that NoC technology can implement interconnection structures that can include router-based, packet switching networks, and others. A logic block or subsystem in a NoC-based chip can have an associated router. A logic block can have a network interface that is the connection between the logic functionality and the network. The data can be directed by a router included in the communications protocol. The data can be sent to one or more nodes within the NoC sub-topology or a node within another NoC sub-topology. The data in one node can be placed on the physical link that carries the data to the next node. In embodiments, the NoC communications protocol includes handshaking between the one or more sub-topologies. In embodiments, separate read and write data buses are provided between the nodes. The read and write data buses can be unidirectional. Thus, the communications protocol can provide a unidirectional data transfer between nodes of the sub-topology. In embodiments, the NoC communications protocol includes a unidirectional data transfer. The first sub-topology can also send a clock signal that can be used as a reference clock input by the interfacing block. In embodiments, the first clock that is sent provides an input to the first DPLL 144 within the interfacing block. For the purposes of data synchronization, the first clock can be included and passed along by the first interface.

The flow 100 includes generating, by the first DPLL, a second clock 150, wherein the generating includes saving, by the interfacing block, the data that was sent. As described above, a first sub-topology can send a first clock to an interfacing unit. A DPLL within the interfacing unit can use the first clock as a reference input to generate an output clock frequency that is different than the input clock frequency. A DPLL can have an output frequency that is a multiple of an input frequency. In embodiments, the first clock and the second clock are based on different clock frequencies. As an example, a first subsystem with its sub-topology can run at a particular frequency, and a second subsystem and sub-topology can run at a different frequency. The DPLL can accommodate the difference between the two subsystems to generate the second frequency. In other embodiments, the second clock is a multiple of the first clock. The DPLL configuration can be set to generate a multiple of the input frequency that will be made available at the DPLL output for the second sub-topology. A further embodiment includes employing, by the second sub-topology, the second clock as a second sub-topology internal clock 152. The data that is stored by the interfacing block will be transferred into the receiving block in synchronization with the DPLL output clock and received by the receiving block in synchronization with the DPLL output clock. Using the DPLL output clock directly as the system clock for the receiving sub-topology can reduce the need for additional subsystem clocks, synchronization, and associated logic.

The flow 100 includes saving 160, by the interfacing block, data that was sent. The data can be saved by latches, flip-flops, and so on. The data can be saved using the clock that was generated by the DPLL. For example, a sending sub-topology can send data and a reference clock. The data can be presented as an input to a latch, flip-flop, etc. within the interfacing unit. Meanwhile, the reference clock can be used by the DPLL to generate a second clock. The second clock can be used to trigger the saving of the data. The saving can accommodate different data bus widths. For example, if the receiving block is a sub-topology with a 32-bit width and the sending sub-topology is a 64-bit width, a FIFO can be provided to save multiple banks of 32-bit data to send to the receiving sub-topology in subsequent clock cycles.

The flow 100 includes forwarding, to the receiving block, by the interfacing block, the second clock 170, wherein the forwarding includes the data 172 that was saved, and wherein the forwarding includes synchronizing the data that was saved with the second clock. As mentioned above and throughout, the DPLL can be configured to receive a first clock. The DPLL can generate a second clock. The second clock frequency can be the same as the input clock frequency, a multiple of the input clock frequency, or some other frequency. The second clock can launch latches, flip-flops, etc. that save data sent from the sending sub-topology. The second clock can then be sent to the receiving block, which can be a receiving sub-topology. The receiving sub-topology can use the second clock to clock all logic operations throughout a portion or all of the sub-topology. The data 172 that was saved can also be forwarded to the receiving sub-topology. The second clock from the DPLL and data that was saved can be in sync when sent to the receiving sub-topology. This can avoid timing issues between NoC sub-topologies that can run at different clock frequencies. Using the FIFO, the forwarding can include multiple cycles of the second clock. This can be used when interfacing a sending sub-topology to a receiving block that uses a different data width. The FIFO can be any size to accommodate multiple data transactions.

A second interfacing block can be included 134 when inserting a first interfacing block between a first sub-topology and a receiving block. In embodiments, the receiving block comprises a second interfacing block. Thus, the flow 100 includes creating, by the second interfacing block, a third clock 180, wherein the creating is based on a second DPLL within the second interfacing block, and wherein the creating includes storing the data 182 that was forwarded. Long RC delays, which do not scale as feature sizes are reduced in subsequent manufacturing technologies, can be problematic to meet timing constraints. In cases such as this, a second interfacing block can be necessary where the first interfacing block is not located close enough to a receiving block. A second interfacing block can be used in other circumstances to meet timing, wiring, performance, or other design constraints. Similar to the first interfacing block, a second interfacing block can contain a second DPLL and data storage elements. Embodiments include storing the data that was forwarded by the first interfacing block. Embodiments include creating, by the second interfacing block, a third clock by the second DPLL.

The flow 100 includes transmitting 190, to a second sub-topology within the plurality of sub-topologies, the third clock, wherein the transmitting includes the data that was stored, and wherein the transmitting includes coordinating the data 192 that was stored with the third clock. The DPLL in the second interfacing block can be configured to receive the second clock as a reference signal. The DPLL in the second interfacing block can use the reference signal to generate a third clock based on the functional requirements of the receiving block in the second sub-topology. The third clock frequency can be the same as the second clock frequency, a multiple of the input clock frequency, or some other frequency. The third clock can be coupled to the clock input of the receiving block. In embodiments, the receiving block comprises a second interfacing block. The data that was saved by the first interfacing block and transmitted to the second interfacing block can be coordinated, or saved, with latches, flip-flops, etc. within the second interfacing block. The third clock can be the trigger for coordinating data from the first interfacing block that was sent to the second interfacing block. Thus, the data and the third clock can be sent to the second sub-topology without timing issues. Further embodiments include using, by the second sub-topology, the third clock as a second sub-topology internal clock 194. Using the output of the DPLL of the second interfacing block directly as the system clock for the receiving sub-topology can reduce the need for additional subsystem clocks and timing synchronization logic.

Various steps in the flow 100 may be changed in order, repeated, omitted, or the like without departing from the disclosed concepts. Various embodiments of the flow 100, or portions thereof, can be included in a computer program product embodied in a non-transitory computer readable medium that includes code executable by one or more processors. Various embodiments of the flow 100, or portions thereof, can be included on a semiconductor chip and implemented in special purpose logic, programmable logic, and so on.

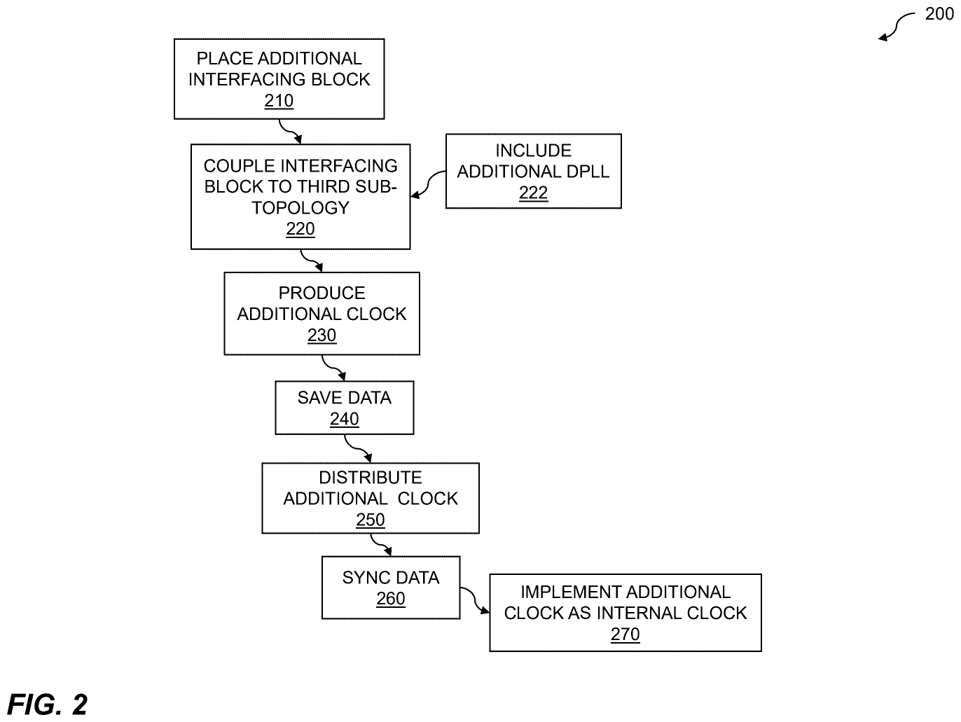

FIG. 2 is a flow diagram for placing an additional interfacing block. Recall that in embodiments, a second interfacing block can be instantiated in series after the first interfacing block. This can be helpful when long RC delays are present in the design, requiring pipelining to meet timing requirements. One or more additional interfacing blocks can also be placed in parallel with the first interfacing block to enable communications to additional receiving blocks. Recall that a first sub-topology can be coupled to a receiving block, wherein the coupling includes inserting an interfacing block, wherein the interfacing block includes a first DPLL. The receiving block can comprise a second sub-topology. In the flow 200, the coupling includes placing an additional interfacing block 210, wherein the additional interfacing block couples 220 the first sub-topology to a third sub-topology within the plurality of sub-topologies, and wherein the additional interfacing block includes an additional DPLL 222. An additional interfacing block can be placed. In general, any number of interfacing blocks can be inserted between any two NoC sub-topologies. Placement can include optimizing a location for the interfacing block that will accommodate the requirements for the receiving block. As an example, an additional interfacing block can be placed closer to circuit elements within the third sub-technology that have more critical timing than other elements of the third sub-technology. The location of the additional interfacing block can be optimized with respect to the previous interfacing block and to the third sub-topology to limit long wire delays. The optimization can be accomplished by a human, a machine place-and-route algorithm, and so on. The results of the place-and-route algorithm can be modified by a human designer to further optimize for a variety of design factors. The additional interfacing block can include an additional DPLL 222 to capture data from the first sub-topology and drive data to the third sub-topology. The additional DPLL 222 can generate an output clock frequency that is different than the input clock frequency. An additional DPLL can have an output frequency that is a multiple of an input frequency.

The flow 200 includes producing, by the additional DPLL, an additional clock 230, wherein the producing includes saving 240, by the additional interfacing block, the data that was sent. The data can be saved by latches, flip-flops, and so on. The data can be saved using the clock that was generated by the additional DPLL. For example, the first sub-topology can send data and a reference clock. The data can be presented as an input to a latch, flip-flop, etc. within the interfacing unit. Meanwhile, the reference clock can be used by the additional DPLL to generate an additional clock. The third clock can be used to trigger the saving of the data. The saving can accommodate different data bus widths. For example, if the third sub-topology includes a 32-bit width and the first sub-topology is a 64-bit width, a FIFO can be provided to save multiple banks of 32-bit data to send to the third sub-topology in subsequent clock cycles.

The flow 200 includes distributing 250, to the third sub-topology, by the additional interfacing block, the additional clock, wherein the distributing includes the data that was saved, and wherein the forwarding includes synchronizing 260 the data that was saved with the additional clock. As described above, the third sub-topology can be in parallel with a second sub-topology. The additional DPLL can be configured to receive a first clock. The additional DPLL can generate an additional clock. The additional clock frequency can be the same as the input clock frequency, a multiple of the input clock frequency, or some other frequency. The additional clock can launch latches, flip-flops, etc. that save data sent from the first sub-topology.

The flow 200 includes implementing, by the third sub-topology, the additional clock as a third sub-topology internal clock 270. The additional clock can be sent to the third sub-topology. The third sub-topology can use the additional clock to clock all logic operations throughout a portion or all of the sub-topology. The data that was saved can also be forwarded to the third sub-topology. The additional clock from the DPLL and data that was saved can be in sync when sent to the third sub-topology. This can avoid timing issues between NoC sub-topologies that can run at different clock frequencies.

Embodiments include the instantiation of additional interfacing blocks in a serial fashion. Such would be the case if a first sub-topology was to be distributed solely to a distant second sub-topology, and more than one interfacing blocks were required to span the distance and meet subsystem requirements. Other embodiments include the instantiation of additional interfacing blocks in a parallel fashion. Such would be the case if a first sub-topology was to be distributed to a second sub-topology and a third sub-topology in parallel.

Various steps in the flow 200 may be changed in order, repeated, omitted, or the like without departing from the disclosed concepts. Various embodiments of the flow 200, or portions thereof, can be included in a computer program product embodied in a non-transitory computer readable medium that includes code executable by one or more processors. Various embodiments of the flow 200, or portions thereof, can be included on a semiconductor chip and implemented in special purpose logic, programmable logic, and so on.

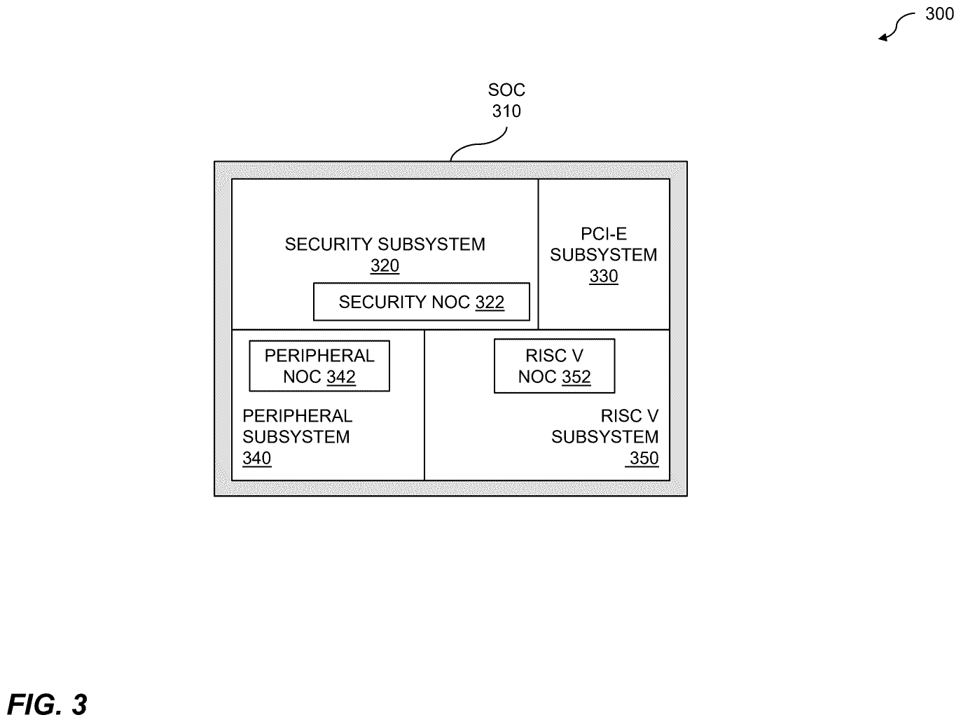

FIG. 3 is an example of a NoC with sub-topologies. In the example 300, an SoC 310 can include one or more logic blocks. The logic blocks on the SoC can include one or more processors, memories, input/output devices, external interfaces, graphics processor units (GPUs), modems, and the like. In the example 300, the logic blocks include a security subsystem 320. The security subsystem can include logic and circuits that provide security functions to an application running on the SoC. The security system can help to prevent cybersecurity attacks on the SoC. The security functions can include encryption/decryption, authenticity verification, verification of security sensors, storage of cryptographic tools, and the like. The SoC 310 can include a PCI-Express (PCIe) subsystem 330. The PCI-Express subsystem can include logic and circuits that provide PCIe communications to and from input/output (I/O) devices. The SoC 310 can include a peripheral subsystem 340. The peripheral subsystem can include logic and circuits that provide an interface to off-chip peripheral devices including input, output, and storage devices, and so on. The SoC 310 can include a RISC V™ subsystem 350. The RISC V™ subsystem can include logic and circuits that provide one or more processing cores, local caches, memory systems, etc. within the SoC. The RISC V™ subsystem 350 is shown illustratively; the subsystem 350 can be based on any architecture such as Arm, X86, and so on. All of the logic subsystem blocks 320, 330, 340, and 350 can be floor planned within the SoC as shown in 310. A plurality of configurations is possible due to wire and performance optimizations. A network-on-a chip (NoC) topology can be created for the SoC, wherein the topology includes one or more sub-topologies, wherein the one or more sub-topologies are based on a physical location of the one or more logic blocks, and wherein each sub-topology in the one or more sub-topologies includes at least one router. The SoC 310 shows three NoC sub-topologies including a security NoC sub-system 322, a peripheral NoC sub-system 342, and a RISC-V NoC sub-system 352. A subsystem can be small enough that it does not require its own NoC sub-topology, as in the case with the PCIe logic block. In embodiments, the PCIe logic block can be coupled to one or more NoC nodes within another sub-topology, for example the RISC V™ NoC sub-topology, to provide packetized communications to other subsystems via their NoC sub-topologies.

As shown in example 300, any NoC sub-topology can be integrated into the floor plan of a logic subsystem. The sub-topologies can include one or more nodes which can be connected with a structure such as a ring, an n-dimensional mesh, a torus, a k-ary tree, a cube mesh, or any other structure. In a usage example, the security NoC sub-topology can run a communications protocol, providing an interface from various points from within the security subsystem to the security NoC sub-topology. In embodiments, the protocol implemented by the logic blocks is translated to the communications protocol running on the sub-topologies. Thus, the interface used by the security subsystem can be translated on to the communications protocol running on the security NoC sub-topology. The communications protocol can be coherent or non-coherent to accommodate the policies of the logic blocks and can include packets to send and receive information between sub-topologies. Thus, the security NoC sub-topology can provide packetized communications to other NoC sub-topologies on the SoC such as the RISC-V NoC sub-topology. The communications protocol can provide a unidirectional data transfer between nodes of the sub-topology. In embodiments, the communications protocol provides a unidirectional data transfer between sub-topologies.

In embodiments, the location of each of the sub-topologies included on the SoC 310 can be optimized. In other embodiments, the node locations within the sub-topology structure can be customized to accommodate the requirements of the logic block. For example, nodes within the sub-topology may be placed closer to circuit elements within the logic block that have more critical timing than other elements of the logic block. The overall size, shape, and/or location of the sub-topology can be optimized to accommodate factors of size, chip location, buffer sizes, quality of service (QOS) policies, arbitration, latency, bandwidth requirements of the logic block, and so on. The location of the sub-topologies within a logic block can be optimized with respect to other sub-topologies to limit long wire delays. In embodiments, the optimizing can be based on a place-and-route algorithm. The results of the place-and-route algorithm can be modified by a human designer to further optimize for one of the factors listed above. In other embodiments, the optimization is performed by the human designer. In further embodiments, the optimization can include machine learning based NOC technology (ML NoC). The optimization can include re-synthesizing the sub-topology with different parameters such as timing constraints, logic minimization, and so on. The optimization can be based on bandwidth or latency requirements.

The sub-topologies can be placed within the SoC, based on the optimization. In embodiments, the placing can comprise physically instantiating a sub-topology within a logic block. Routing can then be finalized within the logic block and the sub-topology at the same time, allowing for optimization of latency and bandwidth. As described above, the sub-topologies can be coupled, wherein the coupling includes a communications protocol. The communications protocol can include packets. Information can be sent in the form of packets from a sending node to a receiving node within the sub-topology. In embodiments, the packets can be sent from a sending node in one sub-topology to a receiving node in another sub-topology using the communications protocol. For example, in FIG. 3, a node with the RISC V™ sub-topology 352 can send information via packets to the security sub-topology through the communications protocol. The packets can comprise a number of flits, or flow control units. In embodiments, the first flit comprises header information which can define the routing path to the receiving node. The receiving node in the security sub-topology can decode the header to determine the final routing destination. In embodiments, a routing calculation is performed by a router within the receiving node of the security sub-topology. The routing calculation can be based on the header.

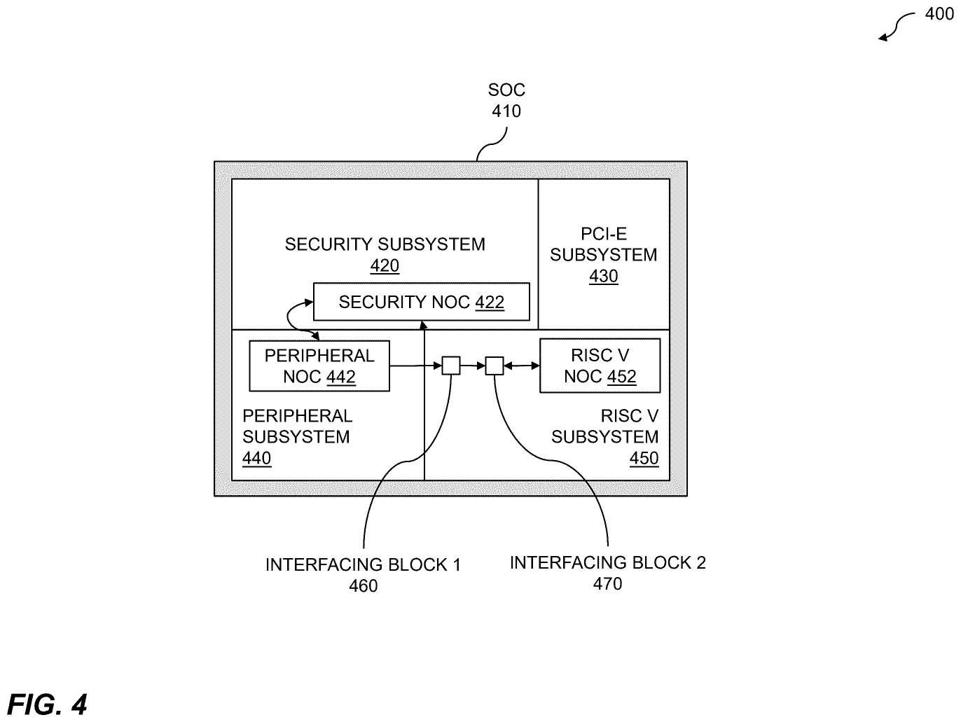

FIG. 4 is an example of a NOC with sub-topologies and interfacing blocks. In the example 400, an SoC 410 can include one or more logic blocks. As described above and throughout, the logic blocks on the SoC can include one or more processors, memory, input/output devices, external interfaces, graphics processor units (GPUs), modems, and the like. A network-on-a chip (NoC) topology can be created for the SoC, wherein the topology includes one or more sub-topologies, wherein the one or more sub-topologies are based on a physical location of the one or more logic blocks, and wherein each sub-topology in the one or more sub-topologies includes at least one router. The sub-topologies can include a structure such as a ring, an n-dimensional mesh, a torus, a k-ary tree, a cube mesh, or any other structure. The location of the sub-topologies within a logic block can be optimized with respect to other sub-topologies to limit long wire delays. The sub-topologies can be placed within the SoC, based on the optimization. In embodiments, the placing can comprise physically instantiating a sub-topology within a logic block. Referring to the example 400, four logic blocks are shown within the SoC 410 floor plan: a security subsystem 420 which includes a NoC sub-topology 422, a PCI-Express (PCIe) subsystem 430, a peripheral subsystem 440 which includes a NOC sub-topology 442, and a RISC V™ subsystem 450 which includes a NOC sub-topology 452. Note that not all logic blocks require their own NoC sub-topology. For example, in FIG. 4, the PCIe subsystem 430 is shown without a sub-topology. This is due to the size of the PCIe logic block. A subsystem can be small enough that it does not require its own NoC sub-topology, as in the case with the PCIe subsystem 430. In embodiments, the PCIe logic block can be coupled to one or more NoC nodes within another sub-topology, for example the RISC V™ NoC sub-topology 452, to provide packetized communications to other subsystems via NoC sub-topologies.

The sub-topologies on SoC 410 can be coupled, wherein the coupling includes a communications protocol. The communications protocol can include packets. Information can be sent in the form of packets from a sending node to a receiving node within the sub-topology. In embodiments, the packets can be sent from a sending node in one sub-topology to a receiving node in another sub-topology using the communications protocol. In example 400, the security NoC sub-topology 422 and the peripheral NoC sub-topology 442 are configured to send data directly to each other. Thus, packetized communications can be enabled between the security subsystem and the peripheral subsystem. However, both the security sub-topology and the peripheral sub-topology are unable to communicate directly with the RISC V™ sub-topology. The inability to communicate directly can be due to a synchronization issue, wire distance, and so on. A combination of synchronization issues between sub-topologies is possible. In embodiments, the data can be synchronized using interfacing blocks. In FIG. 4, two interfacing blocks have been included in the SoC floor plan: interfacing block 1 460 and interfacing block 2 470. These interfacing blocks enable communications between the security, peripheral, and RISC V™ subsystems. Recall that the PCIe subsystem in this floor plan relied upon the RISC V™ NOC sub-topology. Thus, the interfacing blocks enable communications between all logic blocks with the SoC 410. In embodiments, a single interfacing block couples a sending sub-topology to a receiving sub-topology. In other embodiments, such as shown in example 400, multiple interfacing blocks are placed in serial between a sending sub-topology and a receiving sub-topology. In a usage example, this can be necessary when the two sub-topologies are a long distance apart in the floor plan. In embodiments, one or more interfacing blocks comprise one or more pipeline stages to reduce long RC delays in the path between sub-topologies. Multiple interfacing blocks (pipeline stages) can be added to meet timing requirements. Thus, one or more interfacing blocks can be inserted between a sending sub-topology and a receiving sub-topology.

In the example 400, the peripheral NoC 442 can be a first NoC sub-topology, the interfacing block 460 can be an interfacing block, the interfacing block 470 can be an additional interfacing block, and the RISC-V NoC sub-topology can be a second sub-topology. Embodiments include sending, by the first sub-topology 442, to the interfacing block 460, data and a first clock, wherein the first clock provides an input to the first DPLL. The first DPLL can be included in the first interfacing block 460. Further embodiments include generating, by the first DPLL, a second clock, wherein the generating includes saving, by the interfacing block 460, the data that was sent. The second clock can be the same or different than the first clock. The second clock can be a multiple of the first clock, or any other frequency. Additional embodiments include forwarding, to the receiving block, by the interfacing block, the second clock, wherein the forwarding includes the data that was saved, and wherein the forwarding includes synchronizing the data that was saved with the second clock. The receiving block can be the second sub-topology.

An additional interfacing block 470 can be included in the SoC 410. Embodiments include creating, by the second interfacing block 470, a third clock, wherein the creating is based on a second DPLL within the second interfacing block, and wherein the creating includes storing the data that was forwarded. Further embodiments include transmitting, to a second sub-topology 452 within the plurality of sub-topologies, the third clock, wherein the transmitting includes the data that was stored, and wherein the transmitting includes coordinating the data that was stored with the third clock. Additional embodiments include using, by the second sub-topology 452, the third clock as a second sub-topology internal clock. In further embodiments, interfacing blocks 460 and 470 can be placed in parallel to enable communications from a sending sub-topology 442 to more than one receiving sub-topology.

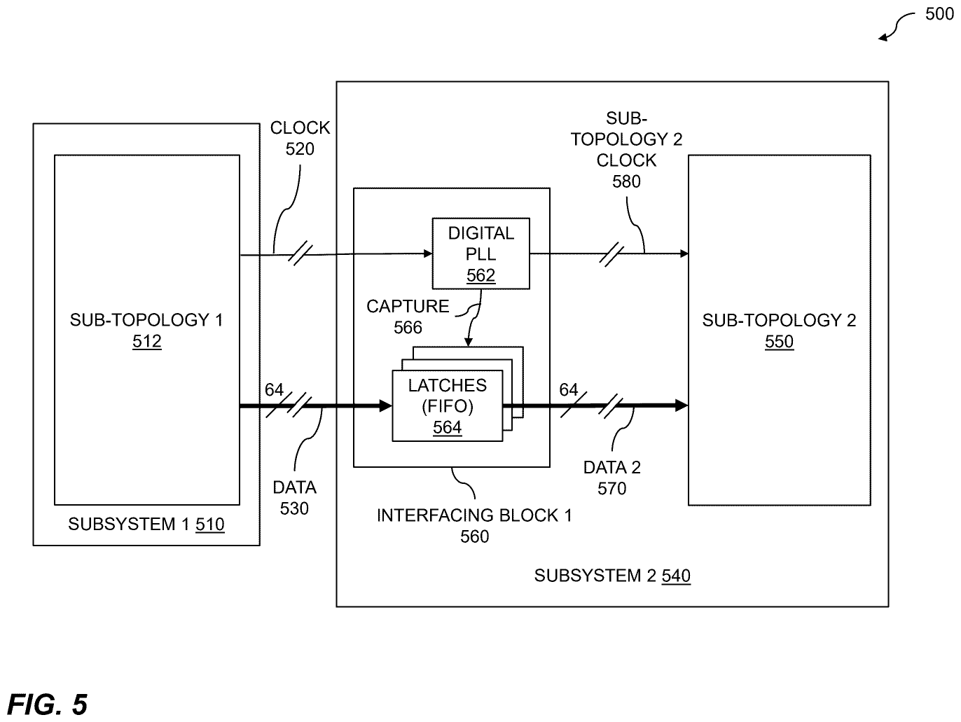

FIG. 5 is a detail of an interfacing block. An interfacing block can contain a pipeline stage to reduce path delays. For example, limitations during floor planning may necessitate long wire path from a sending sub-topology to a receiving sub-topology. Long wire paths can introduce RC delays into signal propagation. Such cases may require a pipeline state to be added. In embodiments, an interfacing block can contain a pipeline stage to reduce path delays.

The detail 500 depicts two subsystems on an SoC. The subsystems, or cores, in an SoC can include one or more central processing units (CPUs), memory, memory interfaces, input/output interfaces, graphic processing units (GPUs), digital signal processors (DSPs) communications interfaces, analog and mixed signal subsystems, power management units, code security subsystems, clock and timing generation systems, and more.

The detail 500 includes a subsystem 1 510. A sub-topology 1 512 is included in subsystem 1 510. Sub-topology 1 512 can contain the network interface that couples the logic blocks in subsystem 1 to a NoC router in sub-topology 1. Sub-topology 1 can provide packetized communications to other sub-topologies within the SoC and can also contain clock and data signals that can be sent to another sub-topology in another subsystem.

The detail 500 includes a clock 520. Subsystems, or cores, can include clock and timing generation logic. Timing signals synchronize data transfers and other system events. The clock 520 can be used to synchronize a transfer of data 530 sent by sub-topology 1 to a receiving block such as interfacing block 1 560. A clock signal can indicate the instant of time when data on a data bus is valid and can be captured. A clock edge can be used to trigger a latch, flip-flop, etc. to capture data into a storage device. Data captures can be rising clock edge triggered, falling clock edge triggered, a combination of the two, or double data rate (DDR) which uses both rising and falling clock edges to capture data into a storage device.

The detail 500 includes data 530. In embodiments, the NoC communications protocol can be coherent, non-coherent, or a mix of the two to accommodate the policies of the logic blocks. Communication between the sub-topology and the logic blocks in the subsystem 1 can include coherent communications protocols such as AMBA 5 CHI, or non-coherent communications protocols such as AXI. In embodiments, additional information is sent by the logic block to a sub-topology 1 node. The information can include sending/receiving logic block ID, coherency data, priority data, or other data. In embodiments, the NoC communications protocol includes packets. The data bus width depicted in the detail 500 example is 64-bits wide. In embodiments, other bit-widths can be used. In other embodiments, control signals are sent by sub-topology 1 512 along with the data 530 for the coordinated receiving of data.

The detail 500 includes a subsystem 2 540. Within subsystem 2 there is embedded a sub-topology 2 550. Subsystem 2 540 can be located a long distance from subsystem 1 510 on the SoC. Finite latency and bandwidth limitations within a core or logic block can cause issues if the connections within the logic block are too distant from the nearest communications node. Wire delay can become insurmountable and does not scale well with chip density. Synchronization and timing closure can thereby present performance limitations despite optimization in floor planning.

Timing closure and performance limitations can be resolved by the addition of an interfacing block 1 560 that is part of the NoC structure. In embodiments, interfacing block 1 560 is inserted within a sub-topology within a subsystem. In further embodiments, the interfacing blocks are inserted in the SoC outside any sub-topology. The interfacing block can include a DPLL 562 and sufficient memory elements to temporarily save data before sending to a receiving block such as sub-topology 2 550. Saving, or buffering, can be performed on a first-in-first-out (FIFO) basis where the first data in is the first data out. A FIFO buffer can be implemented with a hardware shift register, a series of latches, a register, a memory, and so on. Buffering involves the temporary storage of data. The FIFO buffer can be implemented with enough data depth to store expected data volumes without data overruns. In embodiments the memory elements can be latches 564 that are arranged in a FIFO configuration. In embodiments, a capture 566 signal is supplied by the DPLL. The DPLL is coupled to the incoming clock from the sending sub-topology 1 512. This incoming clock can be used by the DPLL as a reference clock to generate sub-topology 2 clock 580. Clock 580 can be the same, a multiple, or otherwise different than the reference clock 520. Clock 580 can be used as the internal clock for sub-topology 2 550. The detail 500 includes data 2 570. Data 2 is sent from the interfacing block 1 560 and received by sub-topology 2 550. In embodiments, data 2 570 can be the same bit-width as the receiving sub-topology 2 550. In other embodiments, data 2 570 can be a different bit-width than the receiving sub-topology 550. In further embodiments, the interfacing block 1 560 can be of sufficient storage bit-width and depth to accommodate the characteristics of sub-topology 2 550. Data can be received at sub-topology 2 550 in synchronization with sub-topology 2 clock 580.

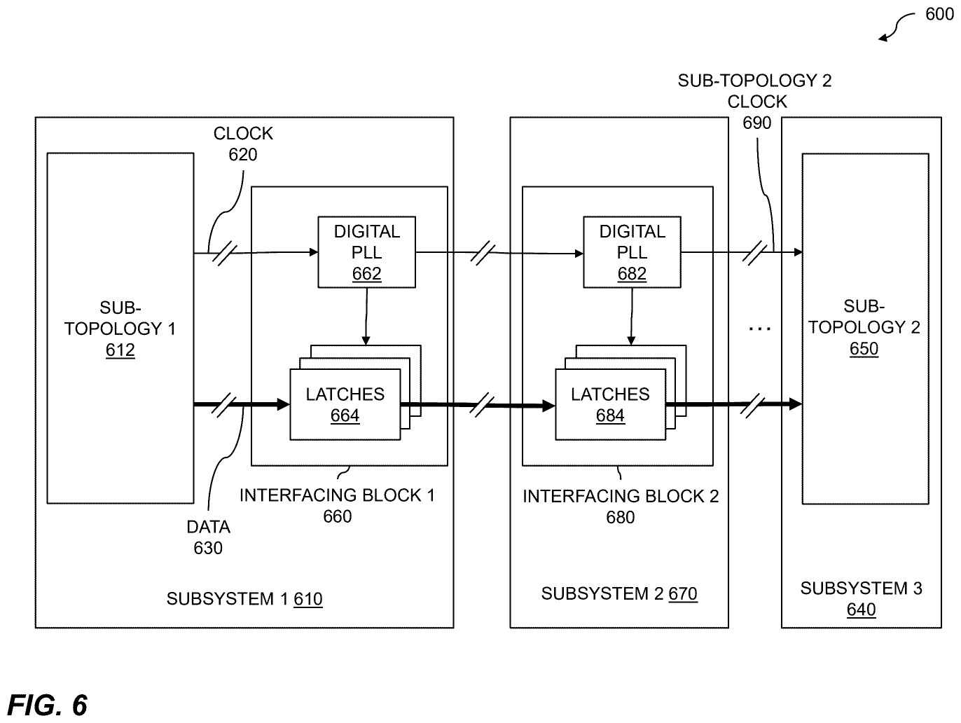

FIG. 6 is an example of multiple interfacing blocks in series. An interfacing block can contain a pipeline stage to reduce path delays. For example, limitations during floor planning may necessitate a long wire path from a sending sub-topology to a receiving sub-topology. Long wire paths can introduce RC delays into signal propagation. Such cases may require a pipeline state to be added. In embodiments, an interfacing block can contain a pipeline stage to reduce path delays. The example 600 depicts three subsystems on an SoC. The subsystems, or cores, in an SoC can include one or more central processing units (CPUs), memory, memory interfaces, input/output interfaces, graphic processing units (GPUs), digital signal processors (DSPs), communications interfaces, analog and mixed signal subsystems, power management units, code security subsystems, clock and timing generation systems, and more.

The example 600 includes a subsystem 1 610. Within subsystem 1 there is embedded a sub-topology 1 612. In embodiments, the SoC includes a NoC topology, wherein the NoC topology includes a plurality of sub-topologies. In other embodiments, a location of each sub-topology within the plurality of sub-topologies is based on a physical location of the plurality of logic blocks. Sub-topology 1 612 can contain the network interface that couples the logic blocks in subsystem 1 to a NoC router in sub-topology 1. Sub-topology 1 can contain a router that couples one node to other nodes in the network. Sub-topology 1 can contain additional clock and data signals that can be sent to another sub-topology in another subsystem. The example 600 includes a clock 620. Subsystems, or cores, can include clock and timing generation logic. Timing signals synchronize data transfers and other system events. The clock 620 can be used to synchronize a transfer of data sent by sub-topology 1 to a receiving block. A clock signal can indicate the instant of time when data on a data bus is valid and can be captured by a receiving device. A clock edge can be used to trigger a latch to capture data into a storage device. Data captures can be rising clock edge triggered, falling clock edge triggered, a combination of the two, or double data rate (DDR) which uses both rising and falling clock edges to capture data into a storage device.

The example 600 includes data 630. In embodiments, additional information is sent by the logic block to a sub-topology 1 node. The information can include sending/receiving logic block ID, coherency data, priority data, or other data. In embodiments, the NoC communications protocol includes packets. The data bus width depicted in the example 600 is 64-bits wide. In embodiments, other bit-widths can be used. In other embodiments, control signals are sent by sub-topology 1 612 along with clock 620 and data 630 for the coordinated receiving of data by a subsequent receiving block. The example 600 includes a subsystem 3 640. Within subsystem 3 there is embedded a sub-topology 2 650. In embodiments, the sub-topology can contain a NoC technology, receive packetized messages, route packetized messages to other nodes in subsystem 3, and forward packetized data to the logic blocks in subsystem 3. In embodiments, subsystem 3 640 can be located a distance away from subsystem 1 610 on the SoC. Finite latency and bandwidth limitations within a core or logic block can cause issues if the connections within the logic block are too distant from the nearest communications node. Wire delay can become insurmountable and does not scale well with chip density. Synchronization and timing closure can thereby present performance limitations despite optimization in floor planning.

Timing closure and performance limitations can be resolved by the addition of an interfacing block 1 660 that is part of the NoC structure. A DPLL 662 can be included in interfacing block 1 660 as well as sufficient memory elements to temporarily save data before sending to a receiving block, which can be interfacing block 2 680. Saving, or buffering, can be performed on a first-in-first-out (FIFO) basis where the first data in is the first data out. A FIFO buffer can be implemented with a hardware shift register, a series of latches, a register, a memory, and so on. Buffering involves the temporary storage of data. The FIFO buffer can be implemented with enough data depth to store expected data volumes without data overruns. In embodiments, the memory elements can be latches 664, flip-flops, or some other memory element. The memory element can be arranged in a FIFO configuration. Receiving and saving data involves timing synchronization with a sending device. A clock edge can indicate valid times for saving data. A clock edge can be used to trigger a latch to capture data into a storage device. In embodiments, a capture signal is supplied by the DPLL. The DPLL is coupled to the incoming clock from the sending sub-topology 1 612. In embodiments, interfacing block 1 660 is inserted within a sub-topology within subsystem 1 610. In further embodiments, the interfacing blocks are inserted in the SoC outside any sub-topology.

The example 600 includes a receiving block that can be a second interfacing block 2 680. A second interfacing block can be used when timing closure and performance limitations necessitate an additional communication pipeline stage within the NoC on the SoC. In further embodiments, the receiving block comprises a second interfacing block. A DPLL 682 can be included in the second interfacing block 680 as well as sufficient memory elements to temporarily save data before sending to a receiving block. Saving, or buffering, can be performed on a first-in-first-out (FIFO) basis, where the first data in is the first data out. A FIFO buffer can be implemented with a hardware shift register, a series of latches, a register, a memory, and so on. The FIFO buffer can be implemented with enough data depth to store expected data volumes without data overruns. In embodiments the memory elements can be latches 684, flip-flops, etc. The memory elements can be arranged in a FIFO configuration. Receiving and saving data involves timing synchronization with a sending device. In embodiments a capture signal is supplied by the DPLL 682. The DPLL 682 can be coupled to the incoming clock from the DPLL 662 within the sending interfacing block 1 660. In embodiments, interfacing block 2 680 is inserted in subsystem 2 670 that is outside sub-topology 1 612 and sub-topology 2 650. In other embodiments, additional interfacing blocks can be added in series as necessary to close timing and obtain performance. Embodiments include creating, by the second interfacing block, a third clock, wherein the creating is based on a second DPLL within the second interfacing block, and wherein the creating includes storing the data that was forwarded. Other embodiments include transmitting, to a second sub-topology within the plurality of sub-topologies, the third clock, wherein the transmitting includes the data that was stored, and wherein the transmitting includes coordinating the data that was stored with the third clock. Other embodiments include using, by the second sub-topology, the third clock as a second sub-topology internal clock

In embodiments, the interfacing block 1 and interfacing block 2 allow bidirectional communications or unidirectional communications. In other embodiments, the NoC communications are packets. In other embodiments, the NoC communications include handshaking between sub-topologies. In further embodiments, the NoC communications protocol is coherent or non-coherent. Clock 690 can be used as the internal clock for sub-topology 2 650.

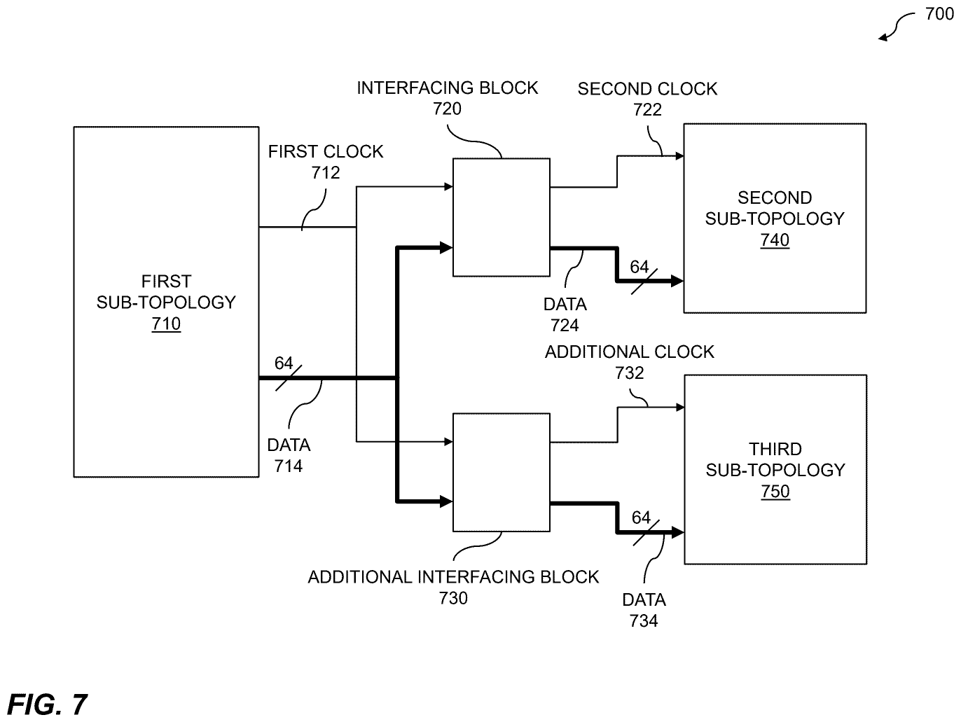

FIG. 7 is an example of interfacing blocks in parallel. This can allow one sub-topology to interface to two other sub-topologies in parallel. An interfacing block can contain a pipeline stage to reduce path delays. For example, limitations during floor planning may necessitate a long wire path from a sending sub-topology to a receiving sub-topology. Long wire paths can introduce RC delays into signal propagation. Such cases may require a pipeline state to be added. In embodiments, an interfacing block can contain a pipeline stage to reduce path delays. The interfacing block can include data buffers. The example 700 depicts three sub-topologies on an SoC. In embodiments, these sub-topologies are in the same subsystem within an SoC. In other embodiments, the sub-topologies are in different subsystems. The subsystems, or cores, in an SoC can include one or more central processing units (CPUs), memory, memory interfaces, input/output interfaces, graphic processing units (GPUs), digital signal processors (DSPs) communications interfaces, analog and mixed signal subsystems, power management units, code security subsystems, clock and timing generation systems, and more.

The example 700 includes a first sub-topology 710. The first sub-topology can contain the network interface that couples the logic blocks in a subsystem to the NoC router in the first sub-topology. The first sub-topology can contain the router that couples one node to other nodes in the network. The first sub-topology can contain clock and data signals that can be sent to a receiving device. The example 700 includes a first clock 712. Subsystems, or cores, can include clock and timing generation logic. Timing signals synchronize data transfers and other system events. The first clock 712 can be used to synchronize a transfer of data 714 sent by the first sub-topology to a receiving block. A clock signal can indicate the instant of time when data on a data bus is valid and can be captured by a receiving device. A clock edge can be used to trigger a latch to capture data into a storage device.

The example 700 includes data 714. In embodiments, the NoC communications protocol can be coherent, non-coherent, or a mix of the two to accommodate the policies of the logic blocks. In embodiments, additional information is sent by the logic block to the first sub-topology node. The information can include sending/receiving logic block ID, coherency data, priority data, or other data. In embodiments, the NoC communications protocol includes packets. The data bus width depicted in the example 700 is 64-bits wide. In embodiments, other bit-widths can be used. In other embodiments, control signals are sent by the first sub-topology 710 along with the first clock 712 and data 714 for the coordinated receiving of data by subsequent receiving blocks.

The example 700 includes an interfacing block 720. The interfacing block 720 couples the first sub-topology 710 to a second sub-topology 740. As explained above and throughout, finite latency and bandwidth limitations within a core or logic block can cause issues if the connections within the logic block are too distant from the nearest communications node. Wire delay can become insurmountable and does not scale well with chip density. Synchronization and timing closure can thereby present performance limitations despite optimization in floor planning. Timing closure and performance limitations can be resolved by the addition of an interfacing block that is part of the NoC structure. A DPLL can be included in interfacing block 720. Additional memory elements can also be included to temporarily save data 714 before sending to a receiving block, which can be another NoC sub-topology. Saving, or buffering, can be performed on a first-in-first-out (FIFO) basis where the first data in is the first data out. A FIFO buffer can be implemented with a hardware shift register, a series of latches, a register, a memory, and so on. The FIFO buffer can be implemented with enough data depth to store expected data volumes without data overruns. In embodiments the memory elements can be latches, flip-flops, etc. The memory elements can be arranged in a FIFO configuration. Receiving and saving data involves timing synchronization with a sending device. A clock edge can indicate valid times for saving data. A clock edge can be used to trigger a latch to capture data into a storage device. In embodiments, a capture signal is supplied by the DPLL within interfacing block 720. The DPLL within interfacing block 720 is coupled to the incoming clock from the sending first sub-topology 710.

The example 700 includes an additional interfacing block 730. The interfacing block 730 couples the first sub-topology 710 to a third sub-topology 750. In embodiments, the coupling includes placing an additional interfacing block, wherein the additional interfacing block couples the first sub-topology to a third sub-topology within the plurality of sub-topologies, and wherein the additional interfacing block includes an additional DPLL. The interfacing block 730 can include an additional DPLL and sufficient memory elements to temporarily save data before sending to a receiving block. Saving, or buffering, can be performed on a first-in-first-out (FIFO) basis where the first data in is the first data out. A FIFO buffer can be implemented with a hardware shift register, a series of latches, a register, a memory, and so on. The FIFO buffer can be implemented with enough data depth to store expected data volumes without data overruns. In embodiments, the memory elements can be latches, flip-flops etc. The memory elements can be arranged in a FIFO configuration. Receiving and saving data involves timing synchronization with a sending device. A clock edge can indicate valid times for saving data. A clock edge can be used to trigger a latch to capture data into a storage device. In embodiments a capture signal is supplied by the additional DPLL within 730. The additional DPLL is coupled to the incoming clock 712 from the sending first sub-topology 710. Embodiments include producing, by the additional DPLL, an additional clock, wherein the producing includes saving, by the additional interfacing block, the data that was sent.

The example 700 includes a second sub-topology 740. The second sub-topology receives a second clock 722 from the interfacing block 720. The second sub-topology receives data 724 from the interfacing block 720. In embodiments, the second clock 722 is used as the internal clock of the second sub-topology 740. Example 700 includes a third sub-topology 750. The third sub-topology receives an additional clock 732 from the additional interfacing block 730. The third sub-topology receives data 734 from the interfacing block 730. Embodiments include distributing, to the third sub-topology, by the additional interfacing block, the additional clock, wherein the distributing includes the data that was saved, and wherein the forwarding includes synchronizing the data that was saved with the second clock. Embodiments include implementing, by the third sub-topology, the additional clock as a third sub-topology internal clock.

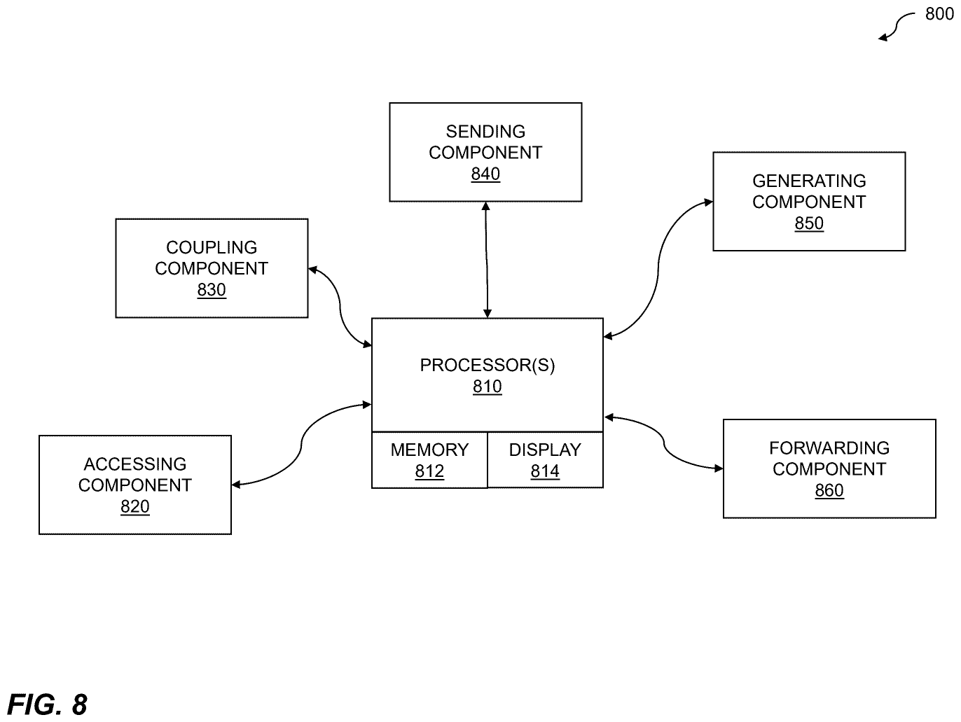

FIG. 8 is a system diagram for coupling network-on-chip sub-topologies with derivative clocks. The disclosed technique couples NoC sub-topologies with interfacing blocks with derivative clocks. The disclosed technique can be useful where timing closure is difficult and performance limitations are significant, and allows resolution by the addition of an interfacing block that is part of the NoC structure.

The system 800 includes processors 810. An SoC can contain one or more processors or processor cores. The processors can include on-chip processors or processor cores, cores that are embedded in application specific integrated circuits (ASICs), soft processors that are implemented in an FPGA or FPGA-like chip, and so on. Processors 810 can be coupled to a memory 812. Memories can be one or more storage units. Memories can be volatile and non-volatile types. Memories can include semiconductor memories, main memory, secondary memory, and so on. The processors 810 can be coupled to a display 814, a keyboard, and one or more other interface devices. A display can reveal system functionality, operating data, statistical parameters, and other useful data. The processor 810, the memory 812, the display 814, and the other peripheral devices can be located in multiple and disparate networked locations, or can be integrated in a single location implemented as a laptop computer, desktop computer, etc.

The system 800 includes an accessing component 820. Embodiments include accessing a system-on-chip (SoC), wherein the SoC includes a plurality of subsystems, wherein each subsystem in the plurality of subsystems includes a plurality of logic blocks, wherein the SoC includes a network-on-a chip (NoC) topology, wherein the NoC topology includes a plurality of sub-topologies, wherein a location of each sub-topology within the plurality of sub-topologies is based on a physical location of the plurality of logic blocks. An SoC can have a plurality of subsystems. Subsystems, or cores, can include a plurality of logic blocks. Subsystems can include an NoC topology for communications between and among sub-topologies. The subsystems, or cores, in an SoC can include CPUs, memories, input/output interfaces, GPUs, DSPs, analog and digital interfaces, and more. Memories can include a hierarchy of primary and secondary memory elements such as flash, ROM, EEPROM, RAM, and so on. NoC sub-topologies can be located based on physical placement of logic blocks.

The system 800 includes a coupling component 830. Embodiments include coupling a first sub-topology within the plurality of sub-topologies to a receiving block, wherein the coupling includes inserting an interfacing block, wherein the interfacing block includes a first digital phased lock loop (DPLL). NoC technology can include router-based packetized communications between a plurality of nodes on an SoC. A network interface logic translates logic communications into a network communications protocol. Network communications are coupled between a sending and a receiving block. There can be communication limitations due to physical properties such as wire RC delay, wiring congestion, and so on. An interfacing clock can be instantiated between a sending block and a receiving block. An interfacing block can have a DPLL and data storage. The DPLL can generate timing signals within the interfacing block. The DPLL can supply an output clock to the next receiving block for the purposes of synchronization of sent data. In embodiments, the DPLL can supply an output clock to the next receiving block for use as an internal clock in a sub-topology.

The system 800 includes a sending component 840. Embodiments include sending, by the first sub-topology, to the interfacing block, data and a first clock, wherein the first clock provides an input to the first DPLL. Data can be sent from a sending sub-topology by use of clock, data, control signals, and other signals. Data can be packetized. Data can be coherent or non-coherent. The data that is sent by the sending sub-topology can be synchronized by the clock that is sent. The clock can be the input to the DPLL in the interfacing block.

The system 800 includes a generating component 850. Embodiments include generating, by the first DPLL, a second clock, wherein the generating includes saving, by the interfacing block, the data that was sent. The DPLL can generate a second clock that is based on the input clock. The DPLL input clock can be received from the sending sub-topology. The second clock can be used for saving the data that was sent from the sending sub-topology. The data can be saved by the interfacing block.

The system 800 includes a forwarding component 860. Embodiments include forwarding, to the receiving block, by the interfacing block, the second clock, wherein the forwarding includes the data that was saved, and wherein the forwarding includes synchronizing the data that was saved with the second clock. The interfacing block can forward stored data to the receiving block. The stored data is synchronized with the second clock that was generated by the DPLL. The second clock can be used to synchronize the data that is forwarded by the interfacing block. The second clock can be used as the system clock within the receiving sub-topology.

The system 800 includes a computer program product embodied in a non-transitory computer readable medium for interfacing electronics, the computer program product comprising code which causes one or more processors to generate semiconductor logic for: accessing a system-on-chip (SoC), wherein the SoC includes a plurality of subsystems, wherein each subsystem in the plurality of subsystems includes a plurality of logic blocks, wherein the SoC includes a network-on-chip (NoC) topology, wherein the NoC topology includes a plurality of sub-topologies, wherein a location of each sub-topology within the plurality of sub-topologies is based on a physical location of the plurality of logic blocks; coupling a first sub-topology within the plurality of sub-topologies to a receiving block, wherein the coupling includes inserting an interfacing block, wherein the interfacing block includes a first digital phased lock loop (DPLL); sending, by the first sub-topology, to the interfacing block, data and a first clock, wherein the first clock provides an input to the first DPLL; generating, by the first DPLL, a second clock, wherein the generating includes saving, by the interfacing block, the data that was sent; and forwarding, to the receiving block, by the interfacing block, the second clock, wherein the forwarding includes the data that was saved, and wherein the forwarding includes synchronizing the data that was saved with the second clock.

The system 800 includes a computer system for interfacing electronics comprising: a memory which stores instructions; one or more processors coupled to the external memory, wherein the one or more processors, when executing the instructions which are stored, are configured to: access a system-on-chip (SoC), wherein the SoC includes a plurality of subsystems, wherein each subsystem in the plurality of subsystems includes a plurality of logic blocks, wherein the SoC includes a network-on-chip (NoC) topology, wherein the NoC topology includes a plurality of sub-topologies, wherein a location of each sub-topology within the plurality of sub-topologies is based on a physical location of the plurality of logic blocks; couple a first sub-topology within the plurality of sub-topologies to a receiving block, wherein the coupling includes inserting an interfacing block, wherein the interfacing block includes a first digital phased lock loop (DPLL); send, by the first sub-topology, to the interfacing block, data and a first clock, wherein the first clock provides an input to the first DPLL; generate, by the first DPLL, a second clock, wherein the generating includes saving, by the interfacing block, the data that was sent; and forward, to the receiving block, by the interfacing block, the second clock, wherein the forwarding includes the data that was saved, and wherein the forwarding includes synchronizing the data that was saved with the second clock.

Each of the above methods may be executed on one or more processors on one or more computer systems. Embodiments may include various forms of distributed computing, client/server computing, and cloud-based computing. Further, it will be understood that the depicted steps or boxes contained in this disclosure's flow charts are solely illustrative and explanatory. The steps may be modified, omitted, repeated, or re-ordered without departing from the scope of this disclosure. Further, each step may contain one or more sub-steps. While the foregoing drawings and description set forth functional aspects of the disclosed systems, no particular implementation or arrangement of software and/or hardware should be inferred from these descriptions unless explicitly stated or otherwise clear from the context. All such arrangements of software and/or hardware are intended to fall within the scope of this disclosure.

The block diagram and flow diagram illustrations depict methods, apparatus, systems, and computer program products. The elements and combinations of elements in the block diagrams and flow diagrams, show functions, steps, or groups of steps of the methods, apparatus, systems, computer program products and/or computer-implemented methods. Any and all such functions—generally referred to herein as a “circuit,” “module,” or “system”—may be implemented by computer program instructions, by special-purpose hardware-based computer systems, by combinations of special purpose hardware and computer instructions, by combinations of general-purpose hardware and computer instructions, and so on.

A programmable apparatus which executes any of the abovementioned computer program products or computer implemented methods may include one or more microprocessors, microcontrollers, embedded microcontrollers, programmable digital signal processors, programmable devices, programmable gate arrays, programmable array logic, memory devices, application specific integrated circuits, or the like. Each may be suitably employed or configured to process computer program instructions, execute computer logic, store computer data, and so on.

It will be understood that a computer may include a computer program product from a computer-readable storage medium and that this medium may be internal or external, removable and replaceable, or fixed. In addition, a computer may include a Basic Input/Output System (BIOS), firmware, an operating system, a database, or the like that may include, interface with, or support the software and hardware described herein.

Embodiments of the present invention are limited to neither conventional computer applications nor the programmable apparatus that run them. To illustrate: the embodiments of the presently claimed invention could include an optical computer, quantum computer, analog computer, or the like. A computer program may be loaded onto a computer to produce a particular machine that may perform any and all of the depicted functions. This particular machine provides a means for carrying out any and all of the depicted functions.

Any combination of one or more computer readable media may be utilized including but not limited to: a non-transitory computer readable medium for storage; an electronic, magnetic, optical, electromagnetic, infrared, or semiconductor computer readable storage medium or any suitable combination of the foregoing; a portable computer diskette; a hard disk; a random access memory (RAM); a read-only memory (ROM); an erasable programmable read-only memory (EPROM, Flash, MRAM, FeRAM, or phase change memory); an optical fiber; a portable compact disc; an optical storage device; a magnetic storage device; or any suitable combination of the foregoing. In the context of this document, a computer readable storage medium may be any tangible medium that can contain or store a program for use by or in connection with an instruction execution system, apparatus, or device.

It will be appreciated that computer program instructions may include computer executable code. A variety of languages for expressing computer program instructions may include without limitation C, C++, Java, JavaScript™, ActionScript™, assembly language, Lisp, Perl, Tcl, Python, Ruby, hardware description languages, database programming languages, functional programming languages, imperative programming languages, and so on. In embodiments, computer program instructions may be stored, compiled, or interpreted to run on a computer, a programmable data processing apparatus, a heterogeneous combination of processors or processor architectures, and so on. Without limitation, embodiments of the present invention may take the form of web-based computer software, which includes client/server software, software-as-a-service, peer-to-peer software, or the like.

In embodiments, a computer may enable execution of computer program instructions including multiple programs or threads. The multiple programs or threads may be processed more or less simultaneously to enhance utilization of the processor and to facilitate substantially simultaneous functions. By way of implementation, any and all methods, program codes, program instructions, and the like described herein may be implemented in one or more thread. Each thread may spawn other threads, which may themselves have priorities associated with them. In some embodiments, a computer may process these threads based on priority or other order.

Unless explicitly stated or otherwise clear from the context, the verbs “execute” and “process” may be used interchangeably to indicate execute, process, interpret, compile, assemble, link, load, or a combination of the foregoing. Therefore, embodiments that execute or process computer program instructions, computer-executable code, or the like may act upon the instructions or code in any and all of the ways described. Further, the method steps shown are intended to include any suitable method of causing one or more parties or entities to perform the steps. The parties performing a step, or portion of a step, need not be located within a particular geographic location or country boundary. For instance, if an entity located within the United States causes a method step, or portion thereof, to be performed outside of the United States, then the method is considered to be performed in the United States by virtue of the causal entity.

While the invention has been disclosed in connection with preferred embodiments shown and described in detail, various modifications and improvements thereon will become readily apparent to those skilled in the art. Accordingly, the spirit and scope of the present invention is not to be limited by the foregoing examples, but is to be understood in the broadest sense allowable by law.

What is claimed is:

1. A processor-implemented method for interfacing electronics comprising:
accessing a system-on-chip (SoC), wherein the SoC includes a plurality of subsystems, wherein each subsystem in the plurality of subsystems includes a plurality of logic blocks, wherein the SoC includes a network-on-chip (NoC) topology, wherein the NoC topology includes a plurality of sub-topologies, wherein a location of each sub-topology within the plurality of sub-topologies is based on a physical location of the plurality of logic blocks;
coupling a first sub-topology within the plurality of sub-topologies to a receiving block, wherein the coupling includes inserting an interfacing block, wherein the interfacing block includes a first digital phased lock loop (DPLL);
sending, by the first sub-topology, to the interfacing block, data and a first clock, wherein the first clock provides an input to the first DPLL;
generating, by the first DPLL, a second clock, wherein the generating includes saving, by the interfacing block, the data that was sent; and
forwarding, to the receiving block, by the interfacing block, the second clock, wherein the forwarding includes the data that was saved, and wherein the forwarding includes synchronizing the data that was saved with the second clock.

2. The method of claim 1 wherein the receiving block comprises a second interfacing block.

3. The method of claim 2 further comprising creating, by the second interfacing block, a third clock, wherein the creating is based on a second DPLL within the second interfacing block, and wherein the creating includes storing the data that was forwarded.

4. The method of claim 3 further comprising transmitting, to a second sub-topology within the plurality of sub-topologies, the third clock, wherein the transmitting includes the data that was stored, and wherein the transmitting includes coordinating the data that was stored with the third clock.

5. The method of claim 4 further comprising using, by the second sub-topology, the third clock as a second sub-topology internal clock.

6. The method of claim 1 wherein the receiving block comprises a second sub-topology, wherein the second sub-topology is within the plurality of sub-topologies.

7. The method of claim 6 wherein the data comprises a communication between NoC subsystems.

8. The method of claim 6 further comprising employing, by the second sub-topology, the second clock as a second sub-topology internal clock.

9. The method of claim 1 wherein the first clock and the second clock are based on different clock frequencies.

10. The method of claim 9 wherein the second clock is a multiple of the first clock.

11. The method of claim 1 wherein the inserting includes a second interfacing block, wherein the second interfacing block provides bi-directional communication between the first sub-topology and the receiving block.

12. The method of claim 1 wherein the interfacing block is located in a different subsystem in the plurality of subsystems than the receiving block.

13. The method of claim 1 wherein the interfacing block is located in a same subsystem in the plurality of subsystems as the receiving block.

14. The method of claim 1 wherein the coupling includes placing an additional interfacing block, wherein the additional interfacing block couples the first sub-topology to a third sub-topology within the plurality of sub-topologies, and wherein the additional interfacing block includes an additional DPLL.

15. The method of claim 14 further comprising producing, by the additional DPLL, an additional clock, wherein the producing includes saving, by the additional interfacing block, the data that was sent.

16. The method of claim 15 further comprising distributing, to the third sub-topology, by the additional interfacing block, the additional clock, wherein the distributing includes the data that was saved, and wherein the forwarding includes synchronizing the data that was saved with the additional clock.

17. The method of claim 16 further comprising implementing, by the third sub-topology, the additional clock as a third sub-topology internal clock.

18. The method of claim 1 further comprising translating, from a protocol running on the plurality of logic blocks, to a NoC communications protocol.

19. The method of claim 18 wherein the NoC communications protocol includes packets.

20. The method of claim 18 wherein the NoC communications protocol includes handshaking between the plurality of sub-topologies.

21. The method of claim 18 wherein the NoC communications protocol includes a unidirectional data transfer.

22. The method of claim 1 further comprising receiving, by the receiving block, the data that was forwarded.

23. A computer program product embodied in a non-transitory computer readable medium for interfacing electronics, the computer program product comprising code which causes one or more processors to generate semiconductor logic for:
accessing a system-on-chip (SoC), wherein the SoC includes a plurality of subsystems, wherein each subsystem in the plurality of subsystems includes a plurality of logic blocks, wherein the SoC includes a network-on-chip (NoC) topology, wherein the NoC topology includes a plurality of sub-topologies, wherein a location of each sub-topology within the plurality of sub-topologies is based on a physical location of the plurality of logic blocks;
coupling a first sub-topology within the plurality of sub-topologies to a receiving block, wherein the coupling includes inserting an interfacing block, wherein the interfacing block includes a first digital phased lock loop (DPLL);
sending, by the first sub-topology, to the interfacing block, data and a first clock, wherein the first clock provides an input to the first DPLL;
generating, by the first DPLL, a second clock, wherein the generating includes saving, by the interfacing block, the data that was sent; and
forwarding, to the receiving block, by the interfacing block, the second clock, wherein the forwarding includes the data that was saved, and wherein the forwarding includes synchronizing the data that was saved with the second clock.

24. A computer system for interfacing electronics comprising:
a memory which stores instructions;
one or more processors coupled to the memory, wherein the one or more processors, when executing the instructions which are stored, are configured to:
access a system-on-chip (SoC), wherein the SoC includes a plurality of subsystems, wherein each subsystem in the plurality of subsystems includes a plurality of logic blocks, wherein the SoC includes a network-on-chip (NoC) topology, wherein the NoC topology includes a plurality of sub-topologies, wherein a location of each sub-topology within the plurality of sub-topologies is based on a physical location of the plurality of logic blocks;
couple a first sub-topology within the plurality of sub-topologies to a receiving block, wherein the coupling includes inserting an interfacing block, wherein the interfacing block includes a first digital phased lock loop (DPLL);
send, by the first sub-topology, to the interfacing block, data and a first clock, wherein the first clock provides an input to the first DPLL;
generate, by the first DPLL, a second clock, wherein the generating includes saving, by the interfacing block, the data that was sent; and
forward, to the receiving block, by the interfacing block, the second clock, wherein the forwarding includes the data that was saved, and wherein the forwarding includes synchronizing the data that was saved with the second clock.
